(19) United States
(12) Patent Application Publication
(10) Pub. No.: US 2026/0141486 A1
(43) Pub. Date: May 21, 2026

(54) System for Object Inference and Image Capture Device

(71) Applicant: Vale, Inc., Charleston, IL (US)

(72) Inventors: Joseph R. Porter, Charleston, IL (US); Tanner W. Metzmeier, Sterling, VA (US)

(21) Appl. No.: 19/397,117

(22) Filed: Nov. 21, 2025

Related U.S. Application Data
(60) Provisional application No. 63/723,187, filed on Nov. 21, 2024.

(51) Int. Cl. G06T 5/50

(52) U.S. Cl. CPC G06T 5/50; G06T 2207/10028; G06T 2207/20081; G06T 2207/20084

(57) ABSTRACT

The wildlife management information system collects, stores, analyzes, and manages image data captured and collected from various image and data sources for objects of interest within a scene of interest. The information system uses various conventional computer hardware to host a cloud-based information structure along with artificial intelligence modeling to generate enhanced images and object inference data from captured digital images and depth data for objects of interest within scenes of interest. The system includes a specialized image captured device that captures or generates both object images and depth data for an object of interest within a scene of interest. The AI modeling allows for improved accuracy and enhanced object inference data.

This application claims the benefit of U.S. Provisional Patent Application, Ser. No. 63/723,187 filed Nov. 21, 2024, the disclosure of which is hereby incorporated by reference.

This invention relates to wildlife monitoring and management systems, and in particular a system and apparatus for improved object inference, including object segmentation and recognition, using enhanced image capture devices and artificial intelligence (“AI”) machine learning models to integrate object images and depth data.

### BACKGROUND OF THE INVENTION

Wildlife management is important to property owners and the public in general. Having an accurate understanding of wildlife populations is critical for managing the population. Wildlife populations are studied and analyzed through observed surveys and analysis. To aid in the study and analysis of wildlife populations, specialized trail cameras, often referred to as “camera traps”, have been developed to document wildlife populations in particular areas. These cameras capture conventional two dimensional photographic images of animals (objects of interest) within a particular scene of interest from which object inferences and population information can be extrapolated, generally from the visual examination of the images. Conventional camera traps only provide two dimensional images, which must be aggregated and analyzed. Often, visually identifying select animals and species and differentiating them from the surrounding background and other animals. within captured two dimensional images is problematic and manually taxing. Captured two dimensional images lack “depth data” i.e., data that enables the image to be represented in three dimensions, which is critical in generating accurate object inference information about any object of interest within any scene of interest. The depth data is critical for understanding the size, shape, direction of movement, distance from the camera to the object of interest. Any object inference information that could be derivable from two dimensional images must be manually interpreted, which is slow and tedious and often produces incomplete and inaccurate information about the detection, classification, recognition and identification (DCRI) of the object. Consequently, conventional wildlife management systems and camera traps remain manually intensive, time consuming and costly.

### SUMMARY OF THE INVENTION

The wildlife management information system of this invention collects, stores, analyzes, and manages image data received and collected from various image and data sources for objects of interest within a scene of interest. The information system uses various conventional computer hardware to host a cloud-based information structure and artificial intelligence modeling to generate object inference data from captured digital images and depth data for objects of interest within scenes of interest. The systems include a specialized image captured device that captures or generates both object images and depth data for an object of interest within a scene of interest. The AI modeling allows for improved accuracy and enhanced object inference data.

The above described features and advantages, as well as others, will become more readily apparent to those of ordinary skill in the art by reference to the following detailed description and accompanying drawings.

### BRIEF DESCRIPTION OF THE DRAWINGS

The present invention may take form in various system and method components and arrangement of system and method components. The drawings are only for purposes of illustrating exemplary embodiments and are not to be construed as limiting the invention. The drawings illustrate the present invention, in which:

FIG. 1 is a simplified schematic drawing of an exemplary embodiment of the image capture device and the cloud based information system of this invention;

FIG. 2 is a perspective view of the image capture device of FIG. 1;

FIG. 3 is a simplified schematic view of the image capture device of FIG. 2;

FIG. 4 is a flow chart of the steps of creating the AI object inference data set of this invention; and

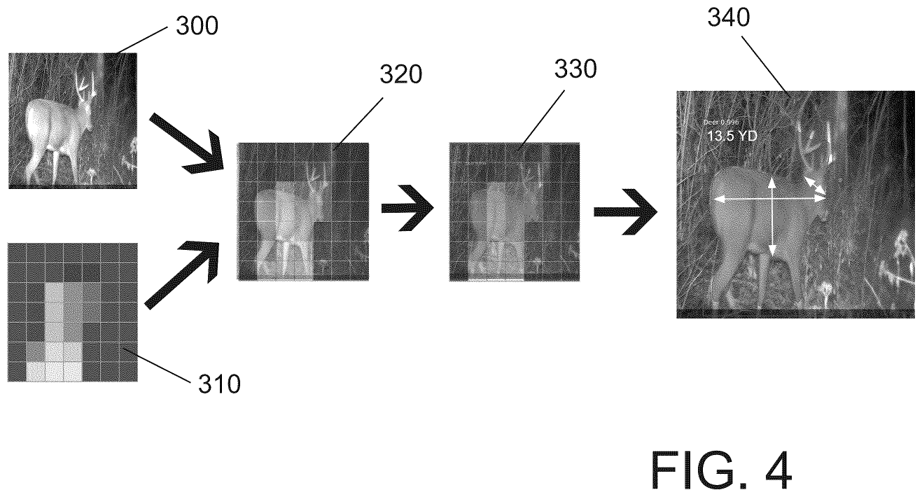

FIG. 5 is a series of images illustrating the progression of generating the AI object inference data set.

### DESCRIPTION OF THE PREFERRED EMBODIMENT

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical, structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

### Key Terms and Definitions

The following is a glossary of terms as used in the description of the preferred embodiment:
Convolution Neural Network (CNN): Convolution neural network is a class of deep learning models, ie. artificial intelligence used to analyze visual images and data.

DCRI: DCRI is an abbreviation of “Detection, Classification, Recognition and Identification” where detection is the ability to determine if there is an object of interest in the camera's field of view, classification is the ability to determine the object of interest's class, such as whether it's a human, animal, vehicle, or boat, recognition is the ability to determine primary features of the object of interest, such as the clothes a person is wearing, and identification is the ability to identify specific details of the object of interest.
Depth Data: Depth Data is digital information related to an object of interest within the scene of interest captured from time-of-flight sensors, a 4D lidar or other related devices, and/or calculated or derived from two dimension (2D) images from manual or artificial intelligence analysis.
Geo-spatial Data: Geo-spatial data refers to geographical coordinates (latitude, longitude, and sometimes altitude) of objects of interest inside a scene of interest within a specific coordinate system.
IR: IR is an abbreviation of infrared and refers to the electromagnetic radiation with wavelengths longer than those of visible light, often used for night vision and heat detection.
LIDAR: LiDAR is a remote sensing device that uses pulsed laser light to measure variable distances, which can be used to create 3D maps and models.
Object Classification. Object classification is the process of categorizing an object of interest into predefined classes or types based on their characteristics or attributes.
Object Images: Object Images are two dimensional (2D) digital images of an object of interest within a scene of interest.
Object Inference Data: Object inference refers to the determination of presence, characteristics, and relationships of objects of interest within a given environment. Object inference includes DCRI, along with Geo-spatical data and other related meta data for an object of interest within a scene of interest.
Object of Interest: Object of interest refers to the specific entities or elements (generally an animal) within a scene of interest that is the focus of attention or analysis.
Object Localization: Object localization is the process of determining the precise physical position of objects within a scene or environment.
Object Recognition: Object recognition is the process of identifying and categorizing an object of interest based on their characteristics or features.
Object Segmentation: Object segmentation is the process of distinguishing objects within an image or video from the surrounding background.
RGB: RGB is an abbreviation for the colors red, green and blue, which are the primary colors of light used in digital imaging systems to reproduce a wide array of colors.
Scene of Interest: Scene of interest refers to the specific area or environment being observed or studied.
Time-of-Flight or ToF: Time-of-Flight (ToF) is a sensor technology that measures distance by timing how long a pulse of light takes to travel from the sensor to an object and back.

### Cloud-Based Information System

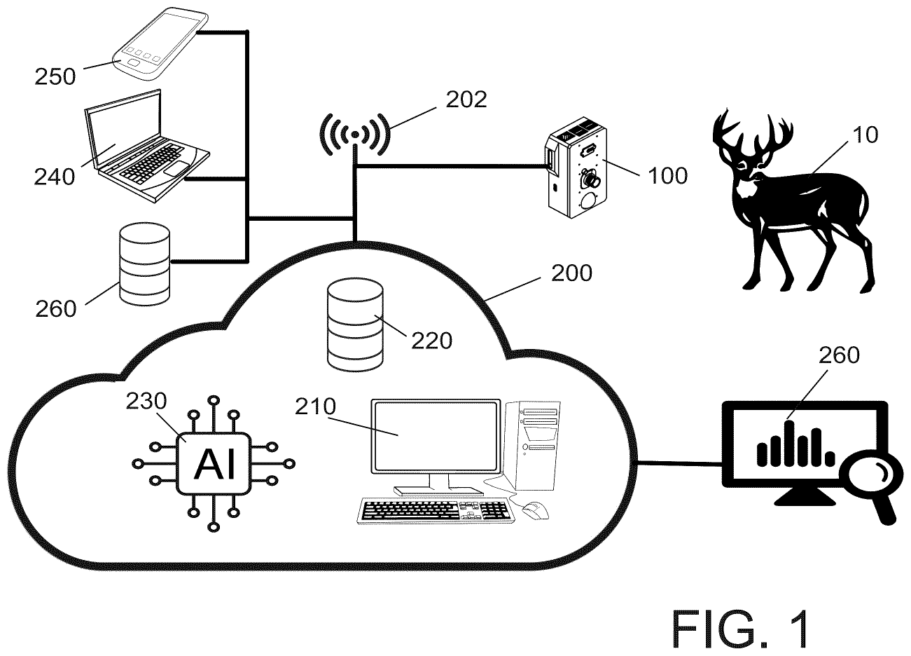

Referring now to the drawings, FIG. 1 illustrates a simplified exemplary schematic of the information systems of this invention, which is designated generally as reference 30 number 200. Information system 200 stores, analyzes, synthesizes and manages image data received and collected from various image and data sources. Information system 200 uses various conventional computer hardware to host a cloud-based information structure and artificial intelligence modeling. Information 200 is adapted to upload, ingest, track and analyze digital images and depth data for objects of interest within scenes of interest from outside sources, such as existing data bases 260, conventional trail cameras and the specialized image capture device of this invention 100, which is designated generally as reference numeral 100. In addition, various localized and remote user interfaces, such as laptops 240, and smart phones 250, can be connected to access and administer information system 200 via wireless network 202 or via other conventional WiFi, cellular or wired connections.

Ideally, information system 200 is a “distributed” cloud based information systems that hosts data storage and analysis software on various networked computer hardware. System 200 includes a central hub or host computer 210, a data storage device 220 and an AI machine learning model 230. Host computer 210 hosts the software used to view, access and administer image data ingested from outside sources, including the specialized image capture device 100. Generally, central hub 210 hosts AI machine learning model 230 as part of information system 200. In other exemplary embodiments of this invention, the AI machine learning model may be integrated and hosted locally within the electronics of ICD 100. ICD 100 communicates and uploads image data to information system 200 via a wireless or cellular network 202.

### AI Machine Learning Model

AI model 230 provides a computational analysis within an artificial intelligence (AI) environment that autonomously deduces or infers the presence, characteristics, and relationships of objects of interest within the given environment of the scene of interest. AI machine learning module 230 is ideally a convolutional neural network incorporating image analysis algorithms, machine learning, pattern recognition techniques, and extensive animal characteristic data sets to analyze and generate a coherent representation of the object of interest within the environment, even in the absence of explicit or direct information. AI model 230 uploads, extrapolates and analyzes digital images and depth data for an object of interest within the scene of interest from various sources, and generates enhanced object inference data with embedded metadata for the object of interest. The enhanced object inference data provides a more complete and detailed image data set for the object of interest within a scene of interest that includes object attributes, interactions and dependencies, as well as, object recognition, segmentation and localization.

### Image Capture Device

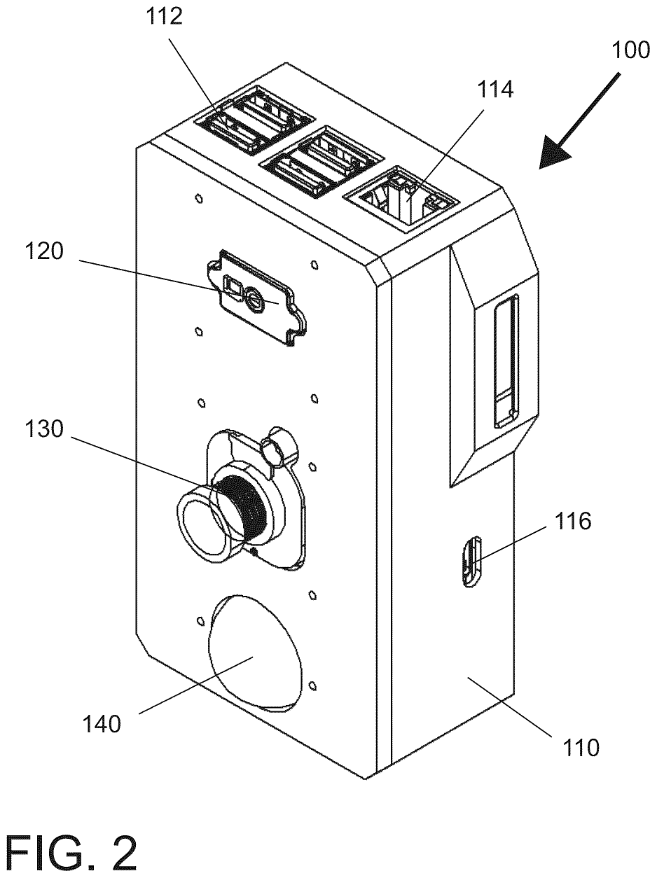

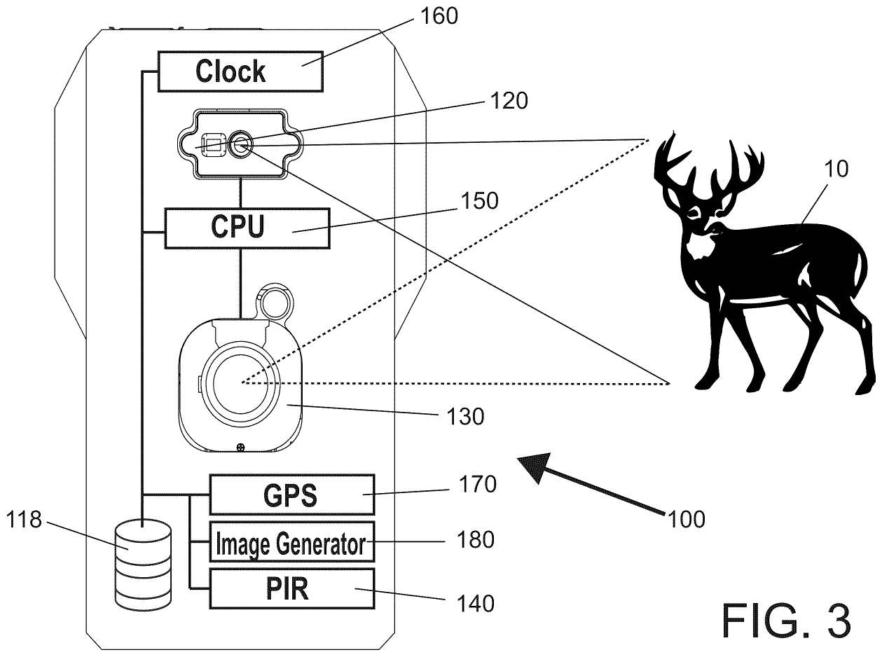

FIGS. 2 and 3, illustrate an exemplary embodiment of the specialized image captured device (“ICD”) of this invention, which is designated generally as reference numeral 100. Ideally, ICD 100 and information system 200 are intended for use in wildlife management, but may be adapted for use in other applications to generate improved object inference data for any object of interest. ICD 100 is used as an image and depth data capture component and forms part of information system 200. ICD 100 is a specialized self-powered, weather proof, portable unit designed to be placed remotely in a scene of interest, i.e. a field or wooded area where animals will be observed. ICD 100 is used in conjunction with AI machine learning model 230 to generate improved object inference data for an object of interest, ideally an animal, within a remote location. Image capture device (“ICD”) 100 captures and integrates both RGB/IR images 300 and depth data in the form of LiDAR (“ToF”) images 310 into an enhanced image of objects of interest 330. In certain embodiments, ICD 100 may include an internal AI model to analyzes the enhanced images 330 and generate an AI object inference data set 350 for the object of interest.

As shown in FIGS. 2 and 3, ICD 100 is a specialized self-powered, weather proof, portable unit designed to be placed remotely in a scene of interest, i.e. a field or wooded area where animals will be observed. ICD 100 captures both RGB/IR images 300 and time-of-flight images 310 for an object of interest 10, i.e., an animal, from a scene of interest. ICD 100 includes a weather proof exterior housing 210 that encloses the internal electronics, circuit boards and sensor modules. ICD 100 is generally powered by its own internal batteries (not shown) and includes a recharging port 112. ICD 100 includes various I/O connectors, such as USB ports 115, a network port 116, which allow the ICD 100 to be connected directly to other devices, such as laptops 240 and smart phones 250. ICD 100 also includes integrated wifi and/or cellular communication components and circuitry (not shown) for sending and receiving wireless data signals between ICD 100 and system 200. In other embodiments, ICD 100 may incorporate removable data storage, such as flash drives, for storing and transferring image data between ICD 100 and information system 200.

Functionally, ICD 100 includes a RGB/IR camera module 120 and a depth data module 130, and passive inferred sensor (PIR) 140, a central processing unit 150, an internal clock 160, a GPS module 170 and an internal image generator 180. Central processing unit (“CPU”) 150 is used to control the various functions and components of ICD 100. CPU 150 generally takes the form of a programmable single-board computer, such as a Raspberry Pi, developed by the Raspberry Pi Foundation. Clock 160 is generally integrated directly into CPU 150 and is used to generate timestamp data associated with the images and data captured by RGB/IR camera module 120, LiDar module 130 and GPS module 170. GPS module 170 is a conventional GPS component integrated into the electronics of ICD 100. GPS module 170 captures various geo-spatial data about ICD 100 and object of interest 10. PIR Sensor 140 is a conventional passive infrared detection component integrated into the electronics of ICD 100, used to detect an object of interest in the proximity to ICD 100.

RGB/IR camera module 120 is a conventional camera component integrated into the electronics of ICD 100. RGB/IR camera module 120 is used to capture an RGB/IR image 300 of object of interest 10. RGB/IR camera module 120 is a high-resolution digital camera of conventional design and function. Preferably RGB/IR camera module 120 has the capability of capturing both RGB and infrared images.

Depth data module 130 generally takes the form of a LIDAR sensor that measures the time delay of the emitted IR pulses and generates a depth data (ToF) image 310 reflecting the depth information of the object of interest from the scene or interest. Each pixel in depth data (ToF) image 310 corresponds to a specific point in the scene. The LIDAR sensor calculates the distance to that point by measuring the time it takes for the emitted light to reflect back. The distance data is then converted into a depth value for the depth data (ToF) image 310. Alternative embodiments of the depth data module 130 may take the form of a Time-of-Flight component that uses pulsed laser light to measure variable distances and velocities based on time of pulse return, which can be used to create 3D images and models.

Image generator 180 is a hardware/software module integrated into the electronics of ICD 100 that synchronizes RGB/IR image 300 and depth data (ToF) image 310 based on timestamps generated from clock 160, maps depth data (ToF) image 310 onto RGB/IR image 300 into a separate overlay image 320, and embeds geo-spatial data from GPS module 170 into an enhanced image 330. Image generator 180 hosts a data fusion algorithm that aligns and integrates the depth map of depth data (ToF) image 310 with the RGB or infrared image of RGB/IR image 300. In certain embodiments of ICD 100 and information 200, the image generator may be hosted within information system 200 independently from ICD 100 to conserve power, storage and internal space within the ICD.

### Process Steps

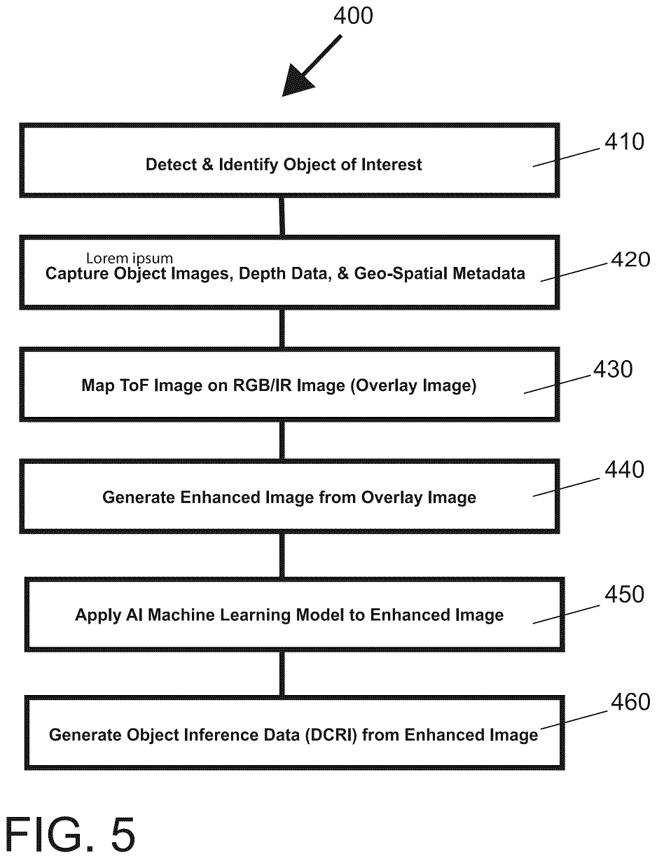

FIG. 5 depicts an exemplary process set of steps (designated generally as reference numeral 400) for creating the capturing and generating the enhanced object inference data using information system 200 and ICD 100 of this invention. The process begins by detecting or identifying an object of interest within a scene of interest—Step 410.

Next, object images, depth data and geo-spatial metadata is collected, captured and uploaded into the information systems 200 from ICD 100 or an outside source-Step 420. Existing digital images of the objects of interest can be upload and imported into the information 200 from any variety of sources including existing image database using conventional data transfer methods and components.

Information system 200 is particularly designed for uploading captured images directly from ICD 100. Generally, ICD 100 is positioned remotely at the desired location and orientation in the field. A user activates ICD 100, which powers and initializes the internal circuitry and sensors and verifies calibration of the RGB/IR camera module 120, depth data module 130 and PIR sensors 140. Once activated, PIR begins sampling the IR spectrum to detect an object of interest within the scene of interest. Once an object of interest is detected within the scene of interest, ICD 100 captures a RGB/IR image 300, depth data (ToF) image 310, a time-stamp (not shown) and geospatial image data (not shown) of object of interest 10-Step 420. RGB/IR camera module 110 captures a digital color or IR image of an object of interest 10. Simultaneously, depth data module 130 generates a depth data (ToF) image 310 of object of interest 10.

Next, information system 200 or ICD 100 creates a composite overlay image 330 from RGB/IR object image 300 and depth data (ToF) image 310—Step 430. Image generator 180 maps the depth data (ToF) image 310 onto RGB/IR object image 300 creating a detailed three-dimensional representation of the depth data from depth data module 130 represented by overlay image 320.

Next, information system 200 or ICD 100 generates an enhanced image 340 embedding Geo-Spatial Metadata into Overlay Image 330-Step 440. This process may be accomplished internally at the ICD level by image generator 180 or at information system 200 level within AI machine learning model 230. Since RGB/IR object images 300 and depth data (ToF) image 310 are captured by two separate components, the images must be synchronized temporally and spatially. Image generator180 uses the time-stamp date from internal clock 160 to synchronize the images and calculates the different viewing angles of ToF module 120 and RGB/IR Camera module 130 to properly align and fuse pixels of the images in overlay image 330. Image generator 180 also translates and calculates the pixel value in ToF image 310 to actual tangible distance value. Image generator 180 embeds geo-spatial metadata onto the overlay image 330 to generate the enhanced image 340.

Next, AI Model 230 is applied to enhanced image 340 for object recognition and segmentation—Step 350. Generally, enhanced image 340 is imported into AI model 230 via information system 200. Enhanced image 340 is initially stored in cloud-based storage memory 220 and accessible to central hub 210 and AI model 230. AI Model 230 analyzes enhanced image 340 to first identify an object of interest, infer its location within the scene of interest and calculate DCRI information for the object of interest. AI Model 130 also embeds a bounding box and segmentation mask onto the enhanced image 340.

Finally, AI Machine Learning Model 230 generates an AI Inference data set 350 for object of interest 10 including DCRI data mapped onto Enhance Image 330—Step 360. AI Inference data set 350 includes enhance image 330 with the object of interest 10 highlighted as separate from the background of the environment. Geo-spatial and other related data for object of interest 10 is displayed on enhanced images, along with object classification and identification information for the object of interest. AI inference data set 350 is stored in memory storage 220 and exported and distributed to end users through central hub 210 and presented in a user-friendly format on a graphic user interface (GUI).

### Advantages

One skilled in the art will note several advantages of the information system and image capture device of this invention. The information system captures, uploads and generates improved object inference data for objects of interest within a scene of interest by mapping captured or derived depth data onto the captured digital image of the object of interest. The central cloud-based information structure can use captured images from a variety of outside sources, as well as the specialized remote ICD of this invention. The ICD includes both a camera module for capturing a digital image of the object of interest and a depth data module for capturing depth data for the object of interest. The information system uses artificial intelligence to analyze and generate the enhanced image and extrapolate object inference data from the enhanced image for the object of interest.

It should be apparent from the foregoing that an invention having significant advantages has been provided. While the invention is shown in only a few of its forms, it is not just limited but is susceptible to various changes and modifications without departing from the spirit thereof. The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

We claim:

1. An image capture device for capturing images of an object of interest from a scene of interest, the device comprising:
a housing;
a camera module carried by the housing for capturing a first digital image of the object of interest;
a depth data module carried by the housing for capturing a second digital images of the object of interest;
an image generator operatively connected to the camera module and the depth data module for generating an enhanced image that overlays the second digital image onto the first digital image; and
a machine learning model operatively connected to the device for analyzing the enhanced image and extrapolating an object inference data set from the enhanced image.

2. The image capture device of claim 1 wherein the depth data module includes a LIDAR component.

3. The image capture device of claim 1 wherein the camera modules captures two-dimensional (2-D) images of the object of interest.

4. The image capture device of claim 1 wherein the camera modules is a high-resolution digital camera.

5. The image capture device of claim 1 and a GPS module carried by the housing for generating geo-spatial data for the Object of interest.

6. The image capture device of claim 5 wherein the image generator embeds geo-spatial data onto the enhanced image.

7. The image capture device of claim 1 wherein the second digital image reflects depth information related to the object of interest within the scene or interest.

8. An information system for generating improved object inference data for an object of interest within a scene of interest, the information system comprises:
a central cloud-based information structure including memory, data storage and a convolution neural network; and an image capture device adapted for use within the information structure,
the image capture device includes a camera module for capturing digital images of the object of interest within the scene of interest,
the information structure includes depth data for the object of interest within the scene of interest,
an image generator for generating an enhanced image that overlays the depth data onto the digital images of the object of interest within the scene of interest, and
a machine learning model for analyzing the enhanced image and extrapolating the improved object inference data of the object of interest within the scene of interest from the enhanced image.

9. The information system of claim 8 wherein the information structure includes a central hub for administering and distributing the object inference data set to end users.

10. The information system of claim 8 wherein the depth data is ingested into the information structure from one of the image capture device, the convolution neural network, and an outside source.

11. The information systems of claim 8 wherein the image capture devices include a depth data module for obtaining the depth data for the object of interest within the scene of interest.

12. A method of generating an improved object inference data for an object of interest within a scene of interest, the method comprising the following steps:
a. Capturing a digital image of the object of interest from the scene of interest;
b. Obtaining depth data for the object of interest within the scene of interest associated with the digital image;
c. Mapping the depth data onto the digital image to create an enhanced image of the object of interest;
d. Applying a machine learning model to the enhanced image of the object of interest to generate the improved object inference data set for the object of interest.

13. The method of claim 12 wherein step b includes obtaining the depth data 28 from a time-of-flight module in an image capture device.

14. The method of claim 12 wherein step c includes mapping the depth data onto the digital image using an image generator within a remote information system.

15. The method of claim 12 wherein step d includes applying a machine learning model to the overlay image using a convolutional neural network hosted within a remote information system.
